(19) United States
(12) Patent Application Publication
(10) Pub. No.: US 2024/0042655 A1
(43) Pub. Date: Feb. 8, 2024

(54) Laminate Tooling Unit And Process For The Manufacture Of Laminate Tooling Unit With Functional Features

(71) Applicant: Mark Kenneth Neizke, Waterford, MI (US)

(72) Inventor: Mark Kenneth Neizke, Waterford, MI (US)

(21) Appl. No.: 18/381,101

(22) Filed: Oct. 17, 2023

Related U.S. Application Data
(63) Continuation-in-part of application No. 17/192,141, filed on Mar. 4, 2021, now abandoned.

(51) Int. Cl. B29C 33/38; B29C 45/43

(52) U.S. Cl. CPC B29C 33/3842; B29C 45/43; B29K 2995/0074; B29K 2995/0097

(57) ABSTRACT

The disclosure includes a laminate tool and a process for producing laminate tooling with functional features between adjacent or non-adjacent laminate segments to provide mechanical leverage to demold a part, space for moving tool segments that allow features to be molded against the line of draw (eliminate die-locked conditions), and passageway for gas to travel. The disclosure further includes a laminate tool with channels in the laminate sheets that communicate at one end to a source of pressurized air and at its opposite end to the mold cavity. The channel permits forced air into the mold cavity to demold the part.

### PRIORITY CLAIM

This application is a continuation in part of U.S. patent application Ser. No. 17/192,141 entitled “Laminate Tooling Unit and Process For The Manufacture of Laminate Tooling Unit With Functional Features”, filed Mar. 4, 2021, which is incorporated by reference herein in its entirety.

### TECHNICAL FIELD

Construction of molds, commonly referred to as tooling, is an integral part of manufacturing technology. Unlike mathematics, chemistry and physics where solutions are derived through application of proven theory, law and experimental result, tool making is a craft comprised of a multitude of engineering disciplines, where previous experience guides one toward what is determined is an optimal solution. Traditional science problems yield a singular answer, whereas within the realm of manufacturing, tooling solutions vary in accordance with the individual's experience given the design task, the value they assign to the chosen variables, and how they rank of importance to them.

In relationship to the cost structure of products, normally stated in materials, labor, burden, and overhead, tooling is an overriding cost factor. Therefore, it is understandable that much effort has been put forth to reduce tool construction cost.

Manuel et al., U.S. Pat. No. 6,587,742 provides for the technology to completely seal the space between laminate plates and eliminate movement of the plates that can disrupt the precisely cut forming surface of the tool cavity. This sealing technology at least partially addresses the problem of the cooling liquid leaking between laminate plates. The interfaces between the plurality of plates were natural leak paths into the cavity and the exterior of the mold.

Weaver, U.S. Pat. No. 5,031,483 discloses a process for manufacturing tooling, e.g., molds, from individual laminations which when stacked in the proper sequence and bonded together define a forming surface. In producing a mold, cut outs are made by a 5 axis cutting means in the individual laminations to provide the shaping surface and optional passageways adjacent the surface through which a heat transfer medium can be made to circulate. Also, selected ones of the laminations may be spaced in the thickness dimension of the mold to provide communication between the mold cavity and a source of pressurized air or vacuum or the atmosphere. The shaping surface is provided with a plurality of narrow slit-like openings in communication with a bore by means of chambers and aperture. The bore is adapted for connection to a source of vacuum, air pressure or atmosphere. The slit-like openings completely surround the mold cavity at each location and are created by providing spacing means between adjacent laminations. The spacing includes elongated strips fixed to the perimeter of the laminations and spacer elements disposed intermediate the shaping surface and the strips. This creates a molded product surface with witness lines on the finished surface.

Lin, US patent Pub No. 2008/0050463 discloses a stacked type tooling formed by stacking a plurality of slices. Each slice has a plurality of patterned openings when these slices are stacked together. The patterned openings form a cavity. Unnecessary volume of the tooling can be avoided to shrink the size of the tooling and let the tooling be airtight. Moreover, the manufacturing cost and time of the tooling can be reduced.

Blog of Sositar Mould “Ejection System” by Jackie Lau, available to public on Jan. 15, 2021 (hereinafter “Lau”) discloses an ejection system as the last step in the plastic injection molding process. After a product solidifies in the mold, an effective method to eject it from the mold is disclosed. During the ejection process the product is protected from deformation, ejector marks, cracking or other damage. The ejection system is a series of different ejectors located on the hidden or backside surface or non-decorative surface of the product.

In one embodiment, the instant disclosure relates to a process and apparatus to manufacture a laminate tool made of individual laminate plates or laminate sheets that may be individually cut to desired configurations and bonded together in a stacked formation to create a molding laminate tool. The individual laminate plates or sheets may be processed to have channels cut partially through the thickness dimension of the laminate plate or sheet to communicate a vacuum, pressurized (forced) air or atmosphere between mold cavity and the source of the vacuum, pressurized (forced) air or atmosphere. It has been found that this arrangement provides minimal surface interruptions (or witness lines or marks) to the molded part and greatly reduces or eliminates any machining of the product surface after ejection from the mold. In addition, these channels provide the ability to draw material into a mold in the case of the injection or vacuum molding, and to permit the user to inject air into the mold cavity through these small channels to eject the part from the mold. The disclosed arrangement greatly minimizes or eliminates any witness marks or lines on the product and simplifies or eliminates machining of the part after ejection from the mold.

In this regard, the laminate tool may further include interruptions along the planar (flat) surfaces of laminate plates to create a functional feature along the plates to provide venting points and to provide space for the mechanical leverage features to demold, eject or remove molded parts from the cavity surface of a laminate tool. Additional part features may be employed against the line of draw through tool actions commonly known as lifters, sides, or cores. These interruptions may occur between adjacent or non-adjacent plates or be present over a multitude of laminate plates as necessary or desired per the part design or tool construction needs. These interruptions do not necessarily have to run along parallel planes between the tool laminate plates, but rather may occur at any intersecting angle among the laminate plates of the laminate tool as required or desired by the tool design and in consideration of parts features.

In one form of the disclosure, the disclosure relates to a method to create a laminate tool by creating a 3D graphic representation of a surface contour of a part that serves to correspond in creating a graphic representation of the part on the tooling surface and sectioning the tooling into a plurality of planar laminate plates or sheets so that each laminate plate or sheet has a determined thickness. The surface contour may include graining features. Graining features may be added to a mold by spraying or etching the gran feature onto the mold cavity prior to forming a part. This may be important when forming coverings for automotive interior panels where graining is an important feature of the part. A plurality of ordered laminate segments may be produced from a sheet or block of material corresponding to the planar laminate of the 3D graphic representation of the tooling. During formation of the planar laminate plates or sheets, a surface of one of the plates or sheets is interrupted to create at least one desired functional feature. The functional features can provide at least one venting point to act as a vacuum in the tooling unit and allow for lifters, cores and slides to facilitate increased mechanical leverage to demold or remove a molded part from the tool unit. The laminate plate or sheet further is provided with a channel having in inlet in fluid communication with a source of vacuum, pressurized (forced) air, or atmosphere, and an outlet in fluid communication with the tool cavity in which the part is formed. The laminate plates that may also include at least one functional feature are assembled into a stack corresponding to the 3D graphic representation to yield the laminate tooling unit with increased mechanical leverage for part removal (or demold) and improved venting.

### SUMMARY

In one aspect, the present disclosure relates to a mold tool to produce a contoured part with reduced witness marks. The tool may include a first fold part formed of at least one planar laminate sheet or plate. Each of the planar laminate sheets or laminate plates has opposed first and second planar faces separated by a sidewall extending substantially unbroken therebetween to define a laminate sheet body. The opposed first and second planar faces of the laminate plates or sheets have a greater length and width than the sidewall and the sidewall defines a thickness of the laminate plate or sheet body. The laminate plates or sheets may be arranged in a stack so that the first planar face of a first laminate sheet or plate is adjacent and abuts to a second planar face of a second laminate sheet or plate in a stack orientation to form the first mold part. The first mold part may have a mold cavity machined or formed in it that corresponds to a part to be molded or formed. The mold cavity has a mold surface that may include graining surface features to impart a grain finish to a molded part. At least one laminate plate or sheet has a channel formed in at least one of the first or second opposed planar faces and extending into the thickness of the laminate sheet body. This channel has an outlet in fluid communication with the mold cavity at a first end and is in fluid communication with a source of pressurized (forced) air, vacuum or atmosphere through an inlet at a second end of said channel. The channel has a greater length than width and extends only partially through the thickness of the laminate plate or sheet. The channel serves to draw a vacuum in the mold cavity to facilitate vacuum molding of a material into the mold, and then permits introduction of pressurized (forced) air to the mold cavity to demold said part from said cavity.

In another embodiment, the tool may include a first mold part and a second mold part. Each of said first and second mold part are formed of at least one planar laminate sheet or laminate plate. Each of the planar laminate sheets or laminate plates has opposed first and second planar faces separated by a sidewall extending substantially unbroken therebetween to define a laminate sheet body. The opposed first and second planar faces of the laminate plates or sheets have a greater length and width than the sidewall and the sidewall defines a thickness of the laminate plate or sheet body. The laminate plates or sheets may be arranged in a stack so that the first planar face of a first laminate sheet or plate is adjacent and abuts to a second planar face of a second laminate sheet or plate in a stack orientation to form each of the first mold part and the second mold part. The first mold part has a male configuration complementary to a female cavity mold configuration formed in said second mold part. The female cavity in the second mold part has a surface contour in a shape of a part to be molded. At least one laminate sheet has a channel formed in at least one of the first or second opposed planar faces and extending into the thickness of the laminate sheet body. This channel has an outlet in fluid communication with the mold cavity at a first end and is in fluid communication with a source of pressurized (forced) air, vacuum or atmosphere through an inlet at a second end of said channel. The channel has a greater length than width and extends only partially through the thickness of the laminate plate or sheet. The channel serves to draw a vacuum in the mold cavity to facilitate injection of material into the mold and permits introduction of pressurized (forced) air to the mold cavity to demold said part from said cavity. Preferably, the channel is formed in a laminate plate or sheet in said second mold part. The channel may be formed in the thickness of two adjacent laminate sheets or plates and may have a circular configuration. The channel is in fluid communication with a bore formed in or passing through the laminate plates or sheets through one of the mold parts at the channel inlet, and the bore in fluid communication with the pressurized (forced) air, atmosphere, or vacuum.

The mold tool as described may further include a functional feature selected from vents, cores, slides and lifters, to facilitate interaction with the mold cavity tooling surface to assist demold of a molded part from said cavity. These functional features are oriented in the mold to interact with a non-finished surface of the part. These functional features may located between adjacent or non-adjacent laminate sheets or plates that may or may not include a channel.

In another aspect, the disclosure relates to a method for creating a laminate tool. The method includes defining a surface contour of a part and then creating a graphic representation of tooling with its tooling surface corresponding to the surface contour of the part. The method includes sectioning a 3D graphic representation of the tooling into a plurality of planar laminate plates or sheets with each planar laminate plate or sheet having a length, a width and a thickness. A plurality of ordered segments may be cut or formed from a sheet material corresponding to said planar laminate plates or sheets. The method includes interrupting a surface of at least one planar laminate to create at least one channel extending from said tooling surface to pressurized (forced) air, atmosphere or vacuum. The channel has a greater length than width and extends only partially through the laminate plate or sheet thickness. The method further includes assembling individual planar laminate plates or sheets into a stack in a predetermined sequence corresponding to the graphic representation of the tooling and securing the individual planar laminate plates or sheets into a laminated tooling unit.

The method or process may also include providing a functional feature in the tool. The functional feature may be at least one of lifters, slides, vents and cores. The functional features extend from the mold cavity to the exterior of the tool. The functional features occur between adjacent or non-adjacent planar laminate sheets with or without a channel. It is also contemplated that the functional features occur along any intersecting angle among said planar lamination plates without a channel.

In one aspect, the disclosure relates to a process and apparatus for the manufacture of a laminate tooling with several channels that may be partially through the thickness dimension of the lamination plate interruptions in the laminate tool cavity surface to create space for vacuum, forced air or atmosphere to communicate between the cavity space and the source of such vacuum, forced air or atmosphere. In addition, interruptions may be located between adjacent, non-adjacent, parallel, non-parallel or at any intersecting angle on the inner or cavity surface of the laminate mold tool unit.

In another aspect the disclosure includes laminate tooling with interruptions along the tooling cavity surface to allow for improved mechanical leverage and venting to facilitate improved removal of molded parts from the cavity without sticking to the individual laminate plates. The interruptions may be termed functional features and it may be desirable to provide at least one venting point, instead of venting lines on the tooling surface. In addition, the functional features may include slides, lifters and cores, which facilitate increased mechanical leverage to remove molded parts from the tooling with minimal interaction with the individual lamination plates.

In another aspect, the disclosure includes a method to manufacture laminate tooling with functional features occurring between adjacent, non-adjacent plates or sheets. The functional features may be oriented parallel, non-parallel and on any intersecting angle on the surface of the laminate tooling unit to provide at least one venting point instead of venting lines as seen in the prior art between the planar laminate plates or sheets on the tooling surface. The functional features also include cores, slide and lifts, which will facilitate in increasing mechanical leverage to ease removal of the molded parts from the tooling with minimal interaction with the individual lamination plates. Briefly, this may be attained by creating a graphic representation corresponding to surface contours on the part to be produced onto the tooling surface. The surface of the tool may be cut by CNC operation or molded or by any other methods to create the negative image of the part to be formed into the surface of the tooling. The tooling is then sectioned and cut into a plurality of planar laminations corresponding to ordered segments of the tooling from a sheet material into the planar laminations thereby creating laminate plates. Each or any plate or sheet can be equipped with interruptions forming a functional feature. The interruptions, or functional features, may be cut or molded into the surface of the planar laminates to create vents, spues, lifters, slides or cores. The planar laminate sheets or plates may be re-stacked back together in accordance with the graphic representation of the tooling to form the laminated tooling unit.

In another aspect, the disclosure relates to creating a graphic representation of a part to be produced on a tooling surface. The tool is cut or molded to have the negative image of the part to be produced. In another aspect, the tooling unit may be a computer simulation with the 3D graphic representation of the part to be produced formed in the mold surface of the tool. In either case, the tooling unit (or computer presentation) may be into a plurality of planar laminations so that each lamination has a determined thickness. By organizing each planar laminate plate or sheet by thickness, a plurality of ordered segments from a sheet material may be produced corresponding to planar laminates to create the laminate plates or sheets. Once brought together, a surface of at least one of the plates is interrupted to create at least one desired functional feature. At least one functional feature can be a channel to allow for at least one venting point to act as a vacuum in the tooling unit. Other functional features may facilitate placement of mechanical leverage components such as lifters, slides and cores to demold or remove a molded part from the tooling unit. The laminate plates are re-assembled into a stack corresponding to the tooling having increased mechanical leverage and venting.

### BRIEF DESCRIPTION OF THE DRAWINGS

FIG. 1 is a schematic representation of a system to manufacture laminate tooling according to one aspect of the disclosure;

FIG. 2 is a flowchart showing the steps for manufacturing laminate tooling according to one aspect of the disclosure;

FIG. 3 is a representational view of a laminate tool according to one aspect of the disclosure;

FIG. 4 is sectional top view of the laminate tool of FIG. 3;

FIG. 5 is a side cross sectional view of the laminate tool of FIG. 3, showing various interruptions or functional features between the laminate plates or sheets;

FIG. 6 is a perspective view of a laminate sheet or laminate plate with a channel formed therein;

FIG. 7 is a perspective view of two adjacent laminate plates or sheets with a channel formed therein.

FIG. 8 is a side view of a stack of laminate plates showing the channel communication with the bore.

### DETAILED DESCRIPTION

Referring now to the discussion that follows and also to the drawings, illustrative approaches to the disclosed systems and methods are described in detail. Although the drawings represent some possible approaches, the drawings are not necessarily to scale and certain features may be exaggerated, removed, sectioned out-of-plane or partially sectioned to better illustrate and explain the present invention. Further, the descriptions set forth herein are not intended to be exhaustive or otherwise limit or restrict the claims to the precise forms and configurations shown in the drawings and disclosed in the following detailed description.

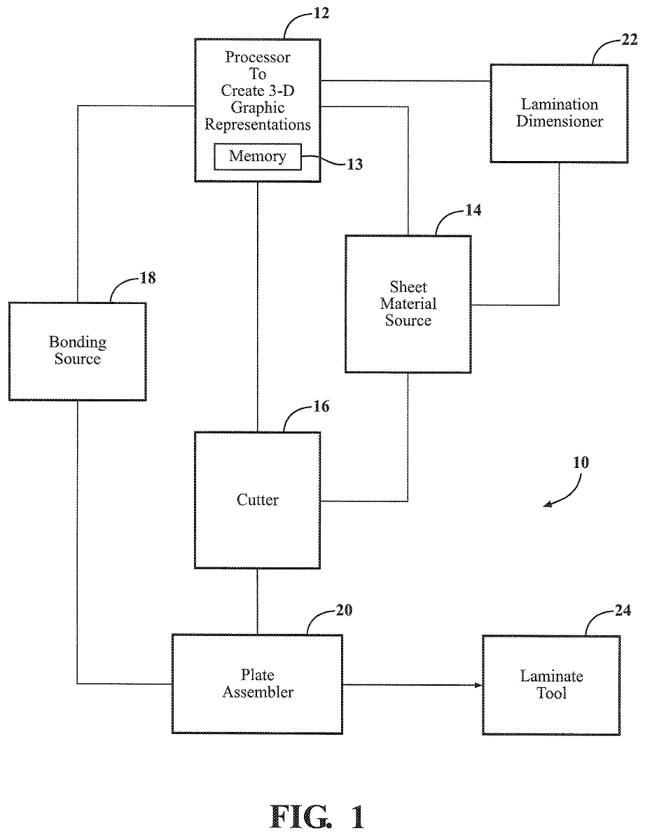

FIG. 1 discloses a schematic representation of a system to create a laminate tooling unit according to one aspect of the disclosure. Specifically, system 10 includes processor 12 having a memory storing instructions capable of creating laminate tooling of any configuration as will be hereinafter described. A 3-D graphic representation of a desired laminate tool may be held in memory and constructed of individual laminate sheets or plates. The processor 12 may communicate with the Laminate Plate or Sheet Dimensioner 22 to select the appropriate dimension for the laminate plate or sheet or the appropriate amount of laminate material necessary to construct the desired laminate plate or sheet. This information is communicated to the sheet or plate material source 14, which may include preformed sheets of laminate or material from which the laminate sheets may be formed. The laminate plates or sheets (or material(s)) are transferred to a cutter 16, which may be a laser cutter, and cut into desired shapes and dimensions. If the laminate sheets or plates are made of a bondable material such as a plastic, the processor may also signal the optional bonding source 18 (as appropriate to the material of the planar laminations) to send bonding agent to the laminate plate assembler to bond the sheets into a laminate tool 24 as desired. A general description of a system to produce a laminate tool as described above may be seen by reference to Manuel, U.S. Pat. No. 6,587,742 incorporated herein by reference.

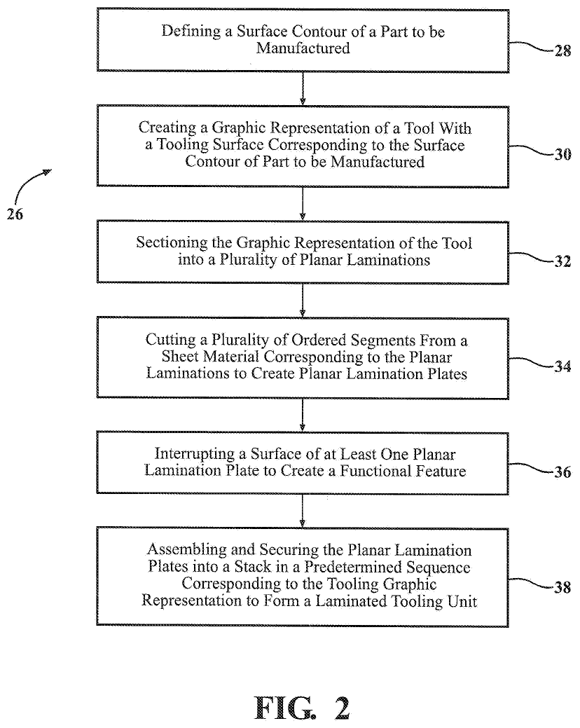

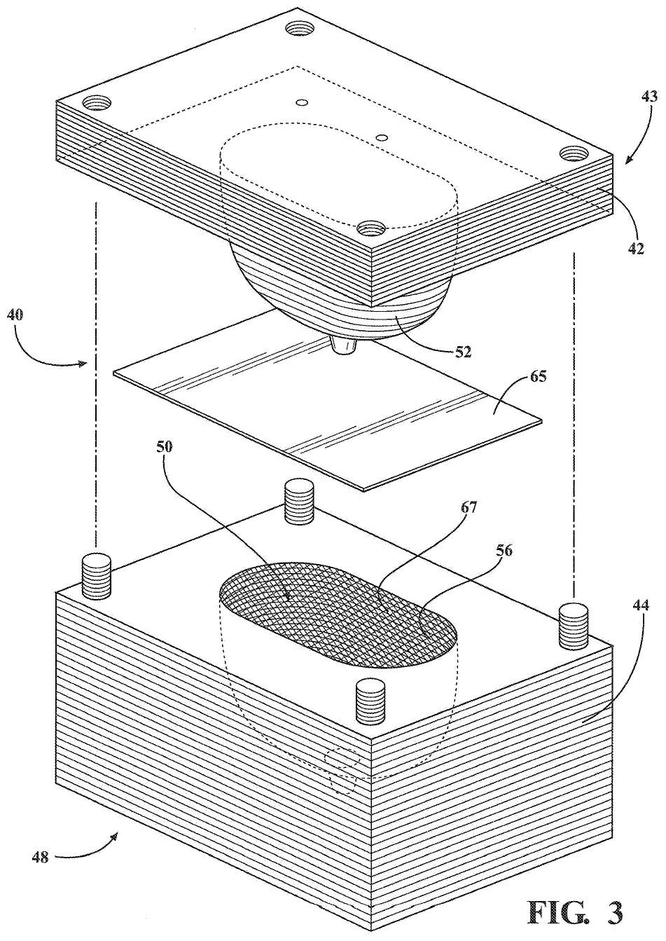

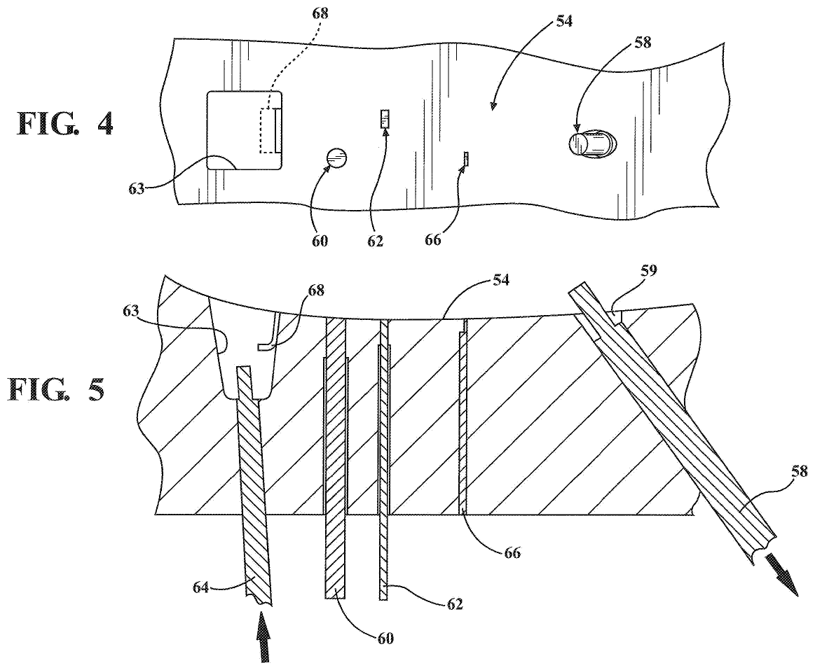

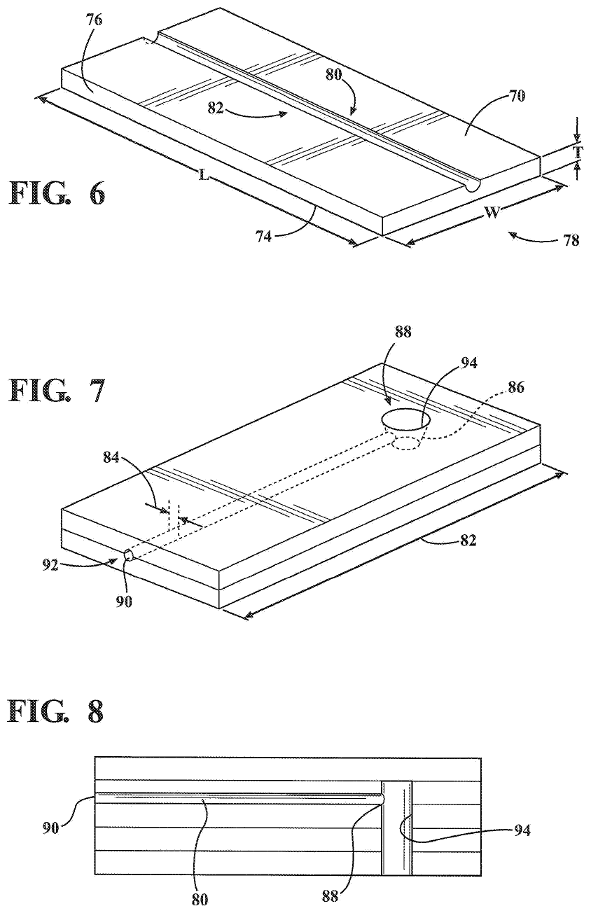

FIG. 2 is a flow chart of one method 26 to produce a laminate tooling according to one embodiment of the disclosure. Step 28 is defining a surface of a contour of a part to be molded. Step 30 is creating a 3D graphic representation of the tool with a tooling surface corresponding to the surface contour of the parts to be manufactured. The tooling may be cut or molded to correspond to the contour of the part to be produced by the laminar tooling. At step 32, the 3D graphic representation of the tooling is sectioned into a plurality of planar laminations. At step 34, the tooling is then cut into a plurality of ordered segments from material corresponding to the planar laminate material to create planar laminate plates or sheets. At step 36, the surface of at least one laminate plate is interrupted to create at least one functional feature. The functional features will be described in greater detail in reference to FIGS. 4 and 5. In addition, at least one surface of a laminate plate or sheet is interrupted to form a channel 80 as will be discussed in reference to FIGS. 6 and 7. At step 38, the laminate plates or sheets are assembled and secured together (such as by bonding) into a stack in a predetermined sequence corresponding to the tooling 3D graphic representation to form the laminate tool unit as shown in FIG. 3.

FIG. 3 shows a representation of a laminate tool 40 suitable for molding parts. The tooling is made of a series of laminate plates or sheets 42 secured together to form a first part 43 of the tooling and laminate plates or sheets 44 to form the second part 48 of the tool. Note the second part of the laminate tool has a mold cavity 50 which is configured to be the mirror image of the mold part contour 52 on the first part 43 such that there is a complementary male to female relationship between the first and second mold parts. Grain features 67 are shown in the surface 56, and it is also understood grain features may also be present in surface 52.

In one aspect, when only on mold part is used to form a part, a thermoformable material sheet 65 may be placed over the cavity 50, and a vacuum induced pulling the formable sheet of material into a mold cavity. When the material cures, the piece is demolded from the cavity.

FIGS. 3, 4 and 5 will be described together. Specifically, FIG. 4 to a sectional top view of mold part 48 looking into the mold cavity 50. FIG. 5 is a side sectional cutaway view of the mold part 48. Shaping or forming surfaces 54 and 56, (See FIG. 3) respectively, create a cavity therebetween representative of the part to be produced. At least one forming surface may be textured or grained, depicted by reference 67. This mold cavity accepts the supply of moldable material under pressure through a spue or gate provided in one or both of the tooling members 43 and 48. The mold members are constructed of a plurality of laminate sheets or plates that are formed, cut or machined to create a shaping surface corresponding to the 3D graphic representation of a part to be molded. At various locales along the mold cavity surface 54, several interruptions may be provided. For example, the interruptions may include slides 58 or cores 59, ejectors 60 and 62, or lifters 64 to interact with a molded part surface corresponding to interruptions over several contiguous plates. In addition, the interruption may also be a vent, such as at 66, or a channel 80 as will be discussed in reference to FIGS. 6 and 7. Importantly, the laminate plates or sheets are, for the most part, in face-to-face contact with each other, being separated only by the various interruptions as described. However, it is equally understood that the interruptions or functional features may occur along adjacent or non-adjacent laminate plates. The construction of the laminate tool creates a mold that does not have venting lines between the laminate plates and greatly reduces or eliminates mold lines or witness lines on a part. After the molding events have occurred, the various lifters, slides or ejectors can be used to mechanical advantage to eject the molded part from the mold. As seen in FIGS. 4 and 5, the doghouse 68 is in the cavity 63. When the lifter 64 is activated, it pushes the part up and away from the doghouse to free the part from the mold. It is also contemplated that the vents or channels can be used to eject parts from the mold by the application of pressurized air through the vent or channels and into the open mold cavity, thereby ejecting the molded part from the cavity. Instead of spacing the plates apart to provide venting, the vent or channel is limited to those functional features that may be between adjacent or non-adjacent plates. The surface of the resulting molded part may be understood to require minimal refinishing to create the molded part with no mold or witness lines.

FIGS. 6, 7 and 8 are detailed views of the laminate sheet or plate according to one aspect of the disclosure. The laminate sheet or plate has a first planar face 70 and an opposed second planar face 74 separated by a sidewall 76 to define a laminate plate or sheet body 78. The planar opposed faces have a length L and a width W. The sidewall has a thickness T. The channel 80 is shown cut into or interrupting the first surface of the laminate sheet or plate. Note the channel does not extend through the entire thickness of the laminate plate or sheet, but rather only extending into the thickens dimension of the laminate plate or sheet. The channel may be circular or semi-circular in cross section or may be any other shape convenient to the toolmaker. The channel has a length 82 which is greater than its width 84. The channel has an inlet 86 at a first end 88 and an outlet 90 at its second end 92. The inlet 86 is in fluid communication with forced or pressurized air, vacuum or atmosphere. This fluid communication at the inlet may be through a bore 94 in the laminate sheets or plates the communicate with a source of pressurized (forced) air, vacuum or atmosphere. The outlet 90 of the channel is in fluid communication with the mold cavity of the tool. When the tool is in operation, the channel serves to communicate a vacuum to the tool cavity to facilitate drawing the molding material, such as a plastic, into the tool cavity. Because the channel outlet is small, there is minimal or no witness line or mark on the molded part. When the part is molded, the channel further serves to permit the introduction of forced or pressurized air into the mold cavity to demold the part.

Those skilled in the art will recognize that the terms in this specification are words of description and not of limitation. Many variations and modifications are visible without departing from the scope and spirit of the invention.

I claim:

1-15. (canceled)

16. A mold tool to produce a contoured part, comprising: a first mold part formed of at least one laminate sheet; said laminate sheet having opposed first and second planar faces separated by a sidewall extending substantially unbroken therebetween to define a laminate sheet body; each said first and second planar faces having a greater length and width than the sidewall; said sidewall defining a thickness of the laminate sheet body;
each said laminate sheet arranged in a stack in a first planar face of a first laminate sheet adjacent to a second planar face of a second laminate sheet orientation to form each of said first mold part; said first mold part having a mold cavity having a surface contour with graining in a shape of a part to be molded;
at least one laminate sheet having a channel formed in at least one of the first or second opposed planar faces and extending into the thickness of the laminate sheet body; said channel having an outlet in fluid communication with said mold cavity at a first end and in fluid communication with a source of air, vacuum or atmosphere through an inlet at a second end of said channel; said channel having greater length than width and extending only partially through the thickness of the laminate body; said channel to draw a vacuum in the mold cavity to facilitate molding of a thermoformable material into the mold cavity and to demold said part from said cavity after curing.

17. The mold tool of claim 16, further including a second mold part, each of said first and second mold part are formed of at least one laminate sheet each; each said laminate sheet having opposed first and second planar faces separated by a sidewall extending substantially unbroken therebetween to define a laminate sheet body; each said first and second planar faces having a greater length and width than the sidewall; said sidewall defining a thickness of the laminate sheet body;
said laminate sheets arranged in a stack in a first planar face of a first laminate sheet adjacent to a second planar face of a second laminate sheet orientation to form each of said first mold part and said second mold part; said first mold part having a male configuration complementary to a female cavity mold configuration formed in said second mold part; said female cavity in said second mold part having a surface contour in a shape of a part to be molded;
at least one laminate sheet having a channel formed in at least one of the first or second opposed planar faces and extending into the thickness of the laminate sheet body; said channel having an outlet in fluid communication with said mold cavity at a first end and in fluid communication with a source of air, vacuum or atmosphere through an inlet at a second end of said channel; said channel having greater length than width and extending only partially through the thickness of the laminate body; said channel to draw a vacuum in the mold cavity to facilitate injection of material into the mold and permit introduction of pressurized air to the mold cavity to demold said part from said cavity.

18. The mold tool of claim 16, wherein said channel is formed in a laminate sheet in said second mold part.

19. The mold tool of claim 16, wherein the channel is formed in the thickness of two adjacent laminate sheets.

20. The mold tool of claim 16, wherein the channel has a circular configuration.

21. The mold tool of claim 16, wherein the channel is in fluid communication with a bore through said mold part at said channel inlet; said bore in fluid communication with said pressurized air, atmosphere or vacuum.

22. The mold tool of claim 16, further including a functional feature selected from vents, cores, slides and lifters, to facilitate interaction with the mold cavity tooling surface to assist demold of a molded part from said cavity.

23. The mold tool of claim 16, further including grain features on the mold cavity surface contour.

24. The mold tool of claim 22, wherein said functional feature is located between adjacent laminate sheets without a channel.

25. A method for creating a laminate tool, comprising:
a) defining a surface contour of a part;
b) creating a graphic representation of tooling with a tooling surface corresponding to the surface contour of the part;
c) sectioning the 3D graphic representation of the tooling into a plurality of planar laminates, each planar laminate having a length, width and thickness;
d) cutting a plurality of ordered segments from a sheet material corresponding to said laminate sheets;
e) interrupting a surface of at least one planar laminate to create at least one channel extending from said tooling surface to pressurized air, atmosphere or vacuum, functional feature;’ said channel having a greater length than width; and extending only partially through said laminate sheet thickness;
f) assembling individual laminate sheets into a stack in a predetermined sequence corresponding to the graphic representation of the tooling and securing the individual planar laminate sheets into a laminated tooling unit.

26. The process of claim 25, further including a functional feature selected from at least one of lifters, slides, vents and cores, said functional feature extending from the mold cavity to an exterior of the tool.

27. The process of claim 25, wherein said surface contour includes graining features.

28. The process of claim 25, wherein the functional features occur between adjacent planar laminate sheets without a channel.

29. The process of claim 25, wherein the functional features occur between non-adjacent planar laminate sheets without a channel.

30. The process of claim 25, wherein the functional features occur along any intersecting angle among said planar laminate sheets without a channel.
